(19) United States
(12) Patent Application Publication
(10) Pub. No.: US 2026/0089472 A1
(43) Pub. Date: Mar. 26, 2026

(54) FLEXIBLE MULTI-NODE AMBIENT SENSING

(71) Applicant: Samsung Electronics Co., Ltd., Suwon-si (KR)

(72) Inventors: Jae Hyun Son, Plano, TX (US); Hossein Najaf-Zadeh, Prosper, TX (US); Mark Trayer, Allen, TX (US)

(21) Appl. No.: 19/329,459

(22) Filed: Sep. 15, 2025

Related U.S. Application Data
(60) Provisional application No. 63/697,282, filed on Sep. 20, 2024.

(51) Int. Cl. H04W 4/38; H04W 4/021; H04W 4/029; G16Y 40/10

(52) U.S. Cl. CPC H04W 4/38; H04W 4/021; H04W 4/029; G16Y 40/10

(57) ABSTRACT

Apparatuses and methods for an ambient sensing operation. A method of a network entity for the ambient sensing operation includes: receiving, from at least two sensor nodes comprising a first sensor node and a second sensor node, first information from the first sensor node and second information from the second sensor node; identifying a data model included in the first and second information, respectively; aggregating each of the data model included in the first and second information into a single data model, wherein the data model includes zone information, ambient context detection information, and sensor information; generating an event report based on the single data model; and transmitting the event report to a sensing analyzer.

### CROSS-REFERENCE TO RELATED APPLICATIONS AND CLAIM OF PRIORITY

The present application claims priority to U.S. Provisional Patent Application No. 63/697,282, filed on Sep. 20, 2024. The contents of the above-identified patent documents are incorporated herein by reference.

### TECHNICAL FIELD

The present disclosure relates generally to ambient sensing systems and, more specifically, the present disclosure relates to a flexible multi-node ambient sensing systems.

### BACKGROUND

Ambient sensing is one of the innovative technical solutions that may enable intelligent home services in the areas of security, safety, well-being, and home care. Most prevalent ambient sensing solutions available in single node sensor products such as passive infrared (PIR), ultrasonic/audio sensor, or radar sensor. A single node sensor usually covers a limited sensing area and multiple device installations may be required to cover the entire home. Sensing capability is often dependent on a sensing modality, thus the scope of use case may be limited. Recent proliferation and advancement of wireless technologies and protocols (e.g., WiFi, ultra-wide band (UWB), Bluetooth low energy (BLE), etc.), whose signal signatures are often available among wireless home devices, provided an opportunity of creating new ambient sensing capability with a wider coverage area, lesser device cost, and more diverse detection contents.

### SUMMARY

The present disclosure relates to flexible multi-node ambient sensing systems.

In one embodiment, a network entity for an ambient sensing operation is provided. The network entity comprises a transceiver configured to receive, from at least two sensor nodes comprising a first sensor node and a second sensor node, first information from the first sensor node and second information from the second sensor node. The network entity further comprises a processor operably coupled to the transceiver, the processor configured to: identify a data model included in the first and second information, respectively, aggregate each of the data model included in the first and second information into a single data model, wherein the data model includes zone information, ambient context detection information, and sensor information, and generate an event report based on the single data model, wherein the transceiver is further configured to transmit the event report to a sensing analyzer.

In another embodiment, a method of a network entity for an ambient sensing operation is provided. The method comprises: receiving, from at least two sensor nodes comprising a first sensor node and a second sensor node, first information from the first sensor node and second information from the second sensor node; identifying a data model included in the first and second information, respectively; aggregating each of the data model included in the first and second information into a single data model, wherein the data model includes zone information, ambient context detection information, and sensor information; generating an event report based on the single data model; and transmitting the event report to a sensing analyzer.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of a communication system according to various embodiments of the present disclosure;

FIG. 2 illustrates an example of an electronic device according to various embodiments of the present disclosure;

FIG. 3 illustrates an example of a smart home ambient sensing IoT solution according to various embodiments of the present disclosure;

FIG. 4 illustrates an example of a multi-nodes ambient sensing system according to various embodiments of the present disclosure;

FIG. 5 illustrates an example of a multi-nodes ambient sensing system/device according to various embodiments of the present disclosure;

FIG. 6 illustrates an example of a multi-nodes ambient sensing system under smart home IoT according to various embodiments of the present disclosure;

FIG. 7 illustrates an example of data modeling for a multi-nodes ambient sensing system according to various embodiments of the present disclosure;

FIG. 8 illustrates an example of a 2^{nd} multi-nodes ambient sensing system according to various embodiments of the present disclosure;

FIG. 9 illustrates an example of a data modeling for a 2^{nd} multi-nodes ambient sensing system according to various embodiments of the present disclosure; and

FIG. 10 illustrates a flowchart of a method for flexible multi-node ambient sensing systems according to various embodiments of the present disclosure.

### DETAILED DESCRIPTION

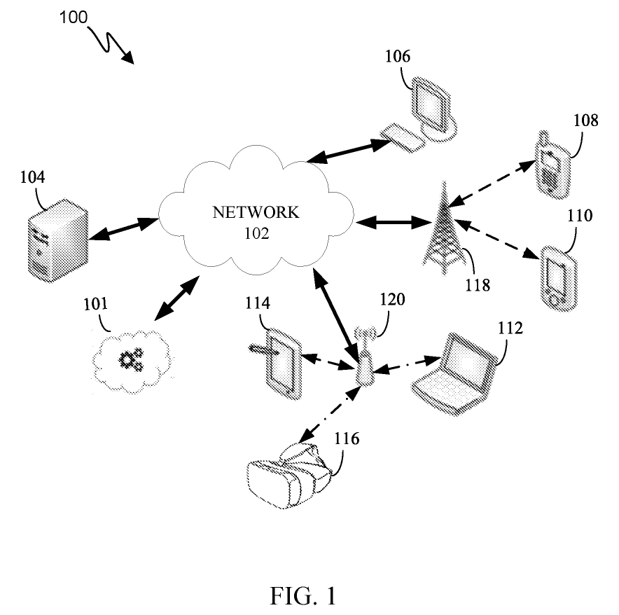

FIGS. 1-10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Ambient sensing is an innovative technical solution enables intelligent home services. Most prevalent ambient sensing solutions are available in single node sensor products such as PIR, ultrasonic/audio sensor, or radar sensor. Recent proliferation and advancement of wireless technologies and protocols (e.g., WiFi, UWB, BLE, etc.), whose signal signatures are often available among wireless home devices, can be utilized for ambient sensing capabilities with a wider coverage area, lesser device cost, and more diverse detection contents.

For example, by analyzing radio frequency (RF) signal parameters obtained among WiFi home devices, it is possible to determine a user occupancy, activity, and situational context while utilizing wireless home devices as multiple sensor nodes. Thus, designing a system architecture and data modeling to best harness multi-nodes sensing system have been an ample research and engineering topic among academia and industry. The present disclosure is intended to address an innovative architecture design and data modeling solution for multi-node ambient sensing system or device solution to enable implementation flexibility, application versatility, enhanced sensor coverage, and cost efficiency.

Some sensor solutions are based on a single node and single sensing modality, often yielding a limited solution scope such as a small sensing coverage area and a simple detection context. Thus, in order to achieve various detection contexts and a wider home sensing coverage area, multiple heterogeneous sensor may need to be purchased and installed, which burdens a home owner with high sensor cost and increased integration complexity.

However, proliferation and advancement of various wireless technologies such as WiFi, UWB, and BLE, whose signal parameters are often available among many wireless home devices, can be utilized to explore those wireless RF signal signatures and parameters to create a path of various ambient sensing solutions to save cost and reduce integration complexity.

Smart home Internet of Things (IoT) standardization may call for an ambient sensing solution to deliver occupancy, human activity, situational awareness detection through established protocols. And multi-nodes ambient sensing solution seems to be the most appropriate candidate for standard realization. Embodiments of the present disclosure provide a multi-nodes ambient sensor solutions for flexible implementation upon diverse multiple sensing nodes. The present disclosure provides embodiments for a multi-node ambient sensing system and architecture design and data modeling to provide ambient sensing solutions.

FIG. 1 illustrates an example of a communication system 100 in accordance with this disclosure. The embodiment of the communication system 100 shown in FIG. 1 is for illustration only. Other embodiments of the communication system 100 can be used without departing from the scope of this disclosure.

As shown in FIG. 1, the communication system 100 includes a network 102 that facilitates communications between various components in the communication system 100. For example, the network 102 can communicate internet protocol (IP) packets, frame relay frames, asynchronous transfer mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 101-116. The client devices 101-116 may be, for example, a smartphone, a tablet computer, a laptop, a personal computer, a TV, an interactive display, a wearable device, a HMD, or an ambient sensor system supporting a flexible multi-node ambient sensing the like. The server 104 can represent one or more servers. Each server 104 includes any suitable computing or processing device that can provide computing services for one or more client devices, such as the client devices 101-116. Each server 104 could, for example, include one or more processing devices, one or more memories storing instructions and data, and one or more network interfaces facilitating communication over the network 102. As described in more detail below, the server 104 can transmit a compressed bitstream, representing a point cloud or mesh, to one or more display devices, such as a client device 101-116.

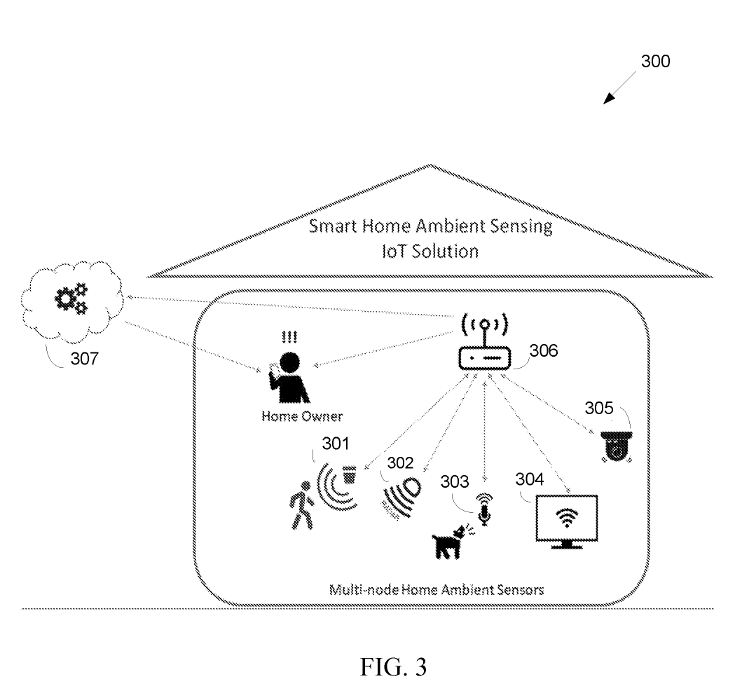

Each client device 101-116 represents any suitable computing or processing device that interacts with at least one server (such as the server 104 as illustrated in FIG. 1) or other computing device(s) over the network 102. The client devices 101-116 include an ambient sensing analyzer 101, a desktop computer 106, a mobile telephone or mobile device 108 (such as a smartphone), a personal digital assistant (PDA) 110, a laptop computer 112, a tablet computer 114, and an HMD 116. However, any other or additional client devices could be used in the communication system 100. The clint devices 106-116 may include an ambient sensing system supporting flexible multi-node ambient sensing (e.g., ambient sensing analyzer 101 as illustrated in FIG. 1) as a part of electronic (client) devices. Or the ambient sensing system, as illustrated in FIG. 3, may be independently and/or individually implemented (e.g., 101 as illustrated in FIG. 1) as a new network entity that communicates with the network 102 and/or each of the client devices 106-116.

Specifically, the ambient sensing analyzer 101 (e.g., 307, as illustrated in FIG. 3) can communicate with the network entity 102 and/or the client devices 106-116 and/or communicate with the server 104, one or more base stations 118 (e.g., cellular base stations or eNodeBs (eNBs)), or one or more wireless access points 120 as illustrated in FIG. 1. In this example, the ambient sensing analyzer can be connected with a home owner (e.g., as illustrated in FIG. 3) and/or multi-node ambient sensing aggregator (e.g., 306 as illustrated in FIG. 3).

In this example, some client devices 101-116 communicate indirectly with the network 102. For example, the mobile device 108 and PDA 110 communicate via one or more base stations 118, such as cellular base stations or eNodeBs (eNBs). Also, the laptop computer 112, the tablet computer 114, and the human mobile device (HMD) 116 communicate via one or more wireless access points 120, such as IEEE 802.11 wireless access points. The ambient sensing analyzer 101 communicate via one or more wireless points 120. Note that these are for illustration only and that each client device 106-116 could communicate directly with the network 102 or indirectly with the network 102 via any suitable intermediate device(s) or network(s). In certain embodiments, the multi-node ambient sensing aggregator 306 may be implemented in the ambient sensing analyzer 101 as a component of the ambient sensing analyzer 101 in a single hardware or a platform.

In certain embodiments, any of the client devices 101-116 transmit information securely and efficiently to another device, such as, for example, the server 104. Also, any of the client devices 101-116 can trigger the information transmission between itself and the server 104.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

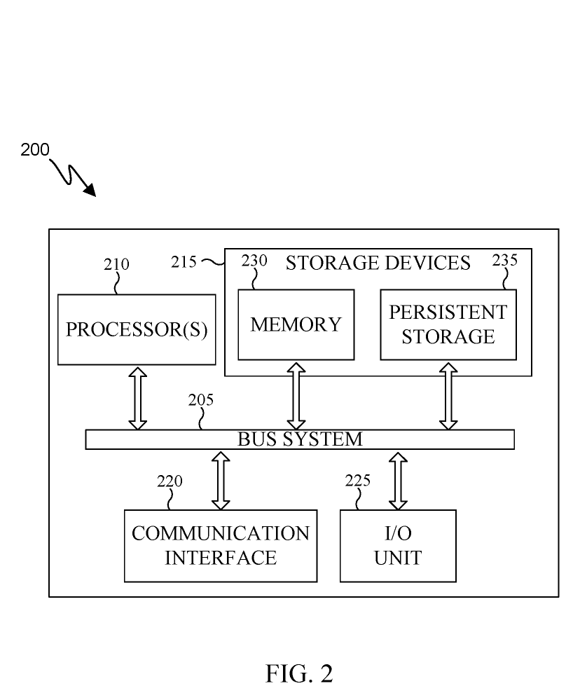

FIG. 2 illustrates an example of an electronic devices in accordance with this disclosure. In particular, FIG. 2 illustrates an example of the server 200, and the server 200 could represent the server 104 in FIG. 1. The server 200 can represent one or more ambient sensing analyzers, multi-node ambient sensing aggregators, local servers, remote servers, clustered computers, and components that act as a single pool of seamless resources, a cloud-based server, and the like. The server 200 can be accessed by one or more of the client devices 101-116 of FIG. 1 or another server.

As shown in FIG. 2, the server 200 can represent one or more local servers, one or more compression servers, one or more ambient sensing analyzers 101 (e.g., 307 as illustrated in FIG. 3), one or more multi-node ambient sensing aggregators (e.g., 306 as illustrated in FIG. 3). As shown in FIG. 2, the server 200 (e.g., one or more ambient sensing analyzers 101 and/or one or more multi-node ambient sensing aggregators ) includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry.

In certain embodiments, the processor 210 can process signals for an ambient sensing analyzer 101 or a multi-mode ambient sensing aggregator. In certain embodiment, the processor 210 can configure individual sensor parameters, control their operation, diagnose sensor fault and operational status, collect and analyze sensor data among multiple sensor nodes and generate a comprehensive detection event report, configure a flexible sensor coverage area according to user defined zones creation, and function as a primary interface entity with other smart home ecosystems, other home devices, and home IoT protocol.

In certain embodiment, the processor 210 can process signals for identifying a data model included in the first and second information, respectively, aggregating each of the data model included in the first and second information into a single data model, wherein the data model includes zone information, ambient context detection information, and sensor information, and generating an event report based on the single data model.

In certain embodiment, the processor 210 can process signals for identifying a sensing operation mode for each of the first and second sensor nodes, identifying to diagnose a sensor fault for each of the first and second sensor nodes, and identifying a sensor operation status for each of the first and second sensor nodes.

In certain embodiment, the processor 210 can process signals for configuring, based on a zone defined by a user, a flexible sensor coverage area for each of the first and second sensor nodes.

In certain embodiment, the processor 210 can process signals for adding a third sensor node and remove at least one of the first sensor node or the second sensor node, configuring sensor node parameters including sensitivity and accuracy parameters for the first sensor node and the second sensor node, turning on and off at least one of the first sensor node or the second sensor node, and configuring to receive at least one of an error or fault message, a battery power level, a level of sensitivity, a level of calibration, or a level of accuracy.

In certain embodiment, the processor 210 can process signals for setting the network entity as an interface circuit or a proxy agent to provide ambient sensing information for Internet of things (IoT) device in an IoT system.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random access memory or any other suitable volatile or non-volatile storage device(s). For example, the instructions stored in the memory 230 can include instructions for the ambient sensing analyzer 101 and/or the multi-node ambient sensing aggregator 306. The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can transmit/receives signals to/from another device such as one of the client devices 101-116, and transmit/receives the signals to/from a human being who is a home owner and/or a multi-node ambient sensing aggregator (e.g., 306, as illustrated in FIG. 3).

In certain embodiment, the communications interface 220 can receive, from at least two sensor nodes comprising a first sensor node and a second sensor node, first information from the first sensor node and second information from the second sensor node.

In certain embedment, the communications interface 220 can transmit the event report to a home owner and/or the multi-node ambient sensing aggregator 306.

In certain embodiment, the communications interface 220 can receive, from the first and second sensor nodes, ambient sensing context for sensing modality and capability of the first and second sensor nodes. In such embodiment, the processor 210 can process a signal, received from the communications interface 220, including the context that comprises at least one of a detection identifier (ID), detection event context, detection location information including information of zones, rooms, or a place identified based on coordinates, active sensor nodes information, object mobility information including a speed and direction, an object range distance, or a detection sensitivity, and a level of confidence and accuracy.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the server 200 occur via a network connection.

FIG. 3 illustrates an example of a smart home ambient sensing IoT solution 300 according to various embodiments of the present disclosure. An embodiment of the smart home ambient sensing IoT solution 300 shown in FIG. 3 is for illustration only.

As illustrated in FIG. 3, the smart home ambient sensing IoT solution may include a passive infrared sensor (PIR) occupancy sensor 301, a radar mobility sensor 302, an audio context sensor 303, a WiFi sensor 304, a close circuit television (CCTV) camera 305, a multi-node ambient sensing aggregator 306, and an artificial intelligent (AI) ambient sensing analyzer (e.g., smart home ecosystem) 307. The smart home ambient sensing IoT solution may include a home owner. The home owner may communicate with the AI ambient sensing analyzer 307 and the multi-node ambient sensing aggregator 306 via a wireless communication system using an LTE, WiFi, UWB, Bluetooth, and or any type of communication protocol. The AI ambient sensing analyzer 307 may communicate with the multi-node ambient sensing aggregator 306 via a wireless communication system using an LTE, WiFi, UWB, Bluetooth, or any type of communication protocol.

The multi-node ambient sensing aggregator 306 may communicate with the PIR occupancy sensor 301, the radar mobility sensor 302, the audio context sensor 303, the WiFi sensor 304, the CCTV camera 305 via a wireless communication system using an LTE, WiFi, UWB, Bluetooth, or any type of communication protocol.

As illustrated in FIG. 1, the AI ambient sensing analyzer 307 may communicate with the network 102 and other client devices 106-116. In certain embodiment, the AI ambient sensing analyzer 307 can be implemented with the multi-node ambient sensing aggregator 306 in a single network entity. In such embodiment, the AI ambient sensing analyzer 307 and the multi-node ambient sensing aggregator 306 communicate each other in a client device (e.g., 101-116 as illustrated in FIG. 1).

In certain embodiment, the multi-node ambient sensing aggregator 306 may communicate with the network 102 directly, without the AI ambient sensing analyzer 307. In such embodiment, the components of the smart home ambient sensing IoT solution may communicate with the network 102 vias the multi-node ambient sensing aggregator 306.

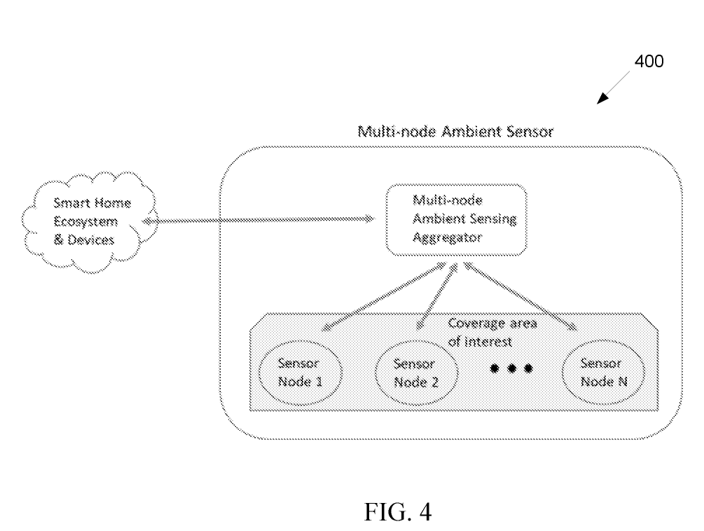

FIG. 4 illustrates an example of a multi-nodes ambient sensing system 400 according to various embodiments of the present disclosure. An embodiment of the multi-nodes ambient sensing system 400 shown in FIG. 4 is for illustration only.

In one embodiment, a multi-node ambient sensing architecture design is provided to render flexible home IoT protocol and data modeling realization. FIG. 4 shows the simplified overview of a multi-nodes ambient sensor design.

In one embodiment, this multi-nodes ambient sensing system may be designed as a multi-nodes ambient sensing aggregator (MASA) as shown in FIG. 4. Its functional roles are listed as follow: (i) configuring individual sensor parameters, control their operation, diagnose sensor fault and operational status; (ii) collecting and analyzing sensor data among multiple sensor nodes and generate a comprehensive detection event report; (iii) configuring a flexible sensor coverage area according to user defined zones creation; and (iv) functioning as a primary interface entity with other smart home ecosystems, other home devices, and home IoT protocol.

As illustrated in the present disclosure, an ambient sensing detection reporting is an important functional output of MASA. The detection report is designed as a list of detection context data structure to accommodate multiple and simultaneous detection contexts. The detection report also includes detection identifier (ID) numbering, detection event context, detection location information such as zones, rooms or specific coordinates, sensor nodes information that involved with the detection event generation, object mobility information (speed & direction), object range distance & direction, detection sensitivity and confidence.

In one embodiment, MASA is to allow the configuration of user defined detection areas. A user can define the detection coverage area of interest in a hierarchical manner; specifying coordinate information to deliver high resolution location information or room/zone detection area information as for the lower resolution. In this embodiment, a zone is considered as a user defined wider area that can encompass multiple rooms and a mandatory detection reporting area. The provided zone configuration accommodates a variety of sensor deployment topology where the detection coverage area and an individual sensor location does not necessarily need to align to each other.

As discussed above, in the present disclosure, an architecture of multi-nodes ambient sensing system is provided, and the detail description of embodiment is provided.

In one embodiment, a multiple-nodes ambient sensor aggregator that provides a great deal of flexibility to control, collect, and analyze diverse sensing data, and interfaces with IoT ecosystems and devices is provided.

In one embodiment, multiple and simultaneous ambient sensing detection contexts are provided through a list of detection data structure.

These embodiment enables user defined location configuration to support full flexibility of integrating diverse individual sensor types and coverage capability.

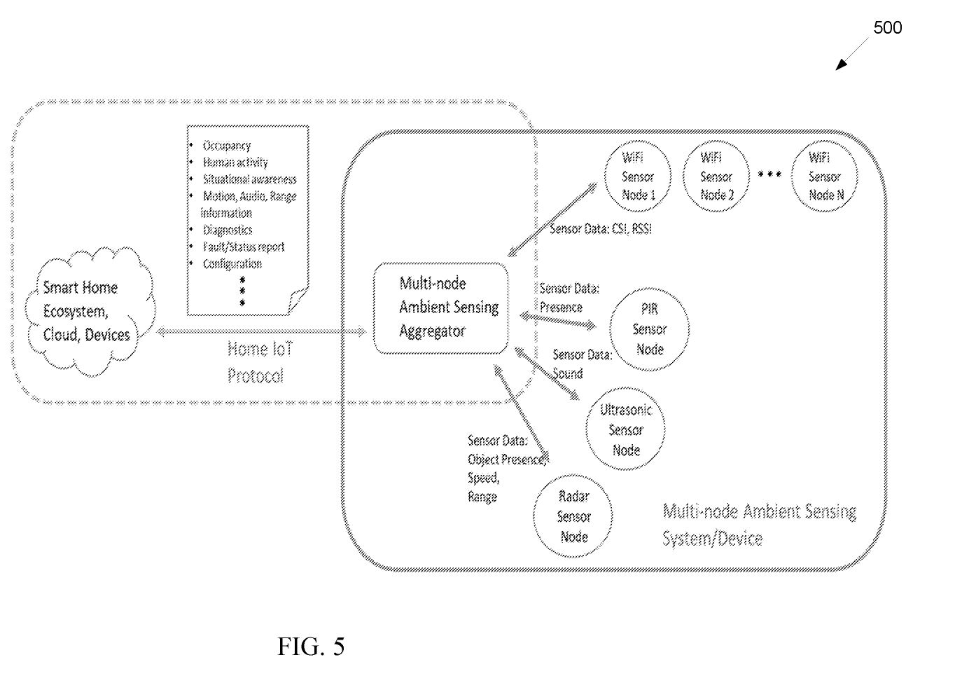

FIG. 5 illustrates an example of a multi-nodes ambient sensing system/device 500 according to various embodiments of the present disclosure. An embodiment of the multi-nodes ambient sensing system/device 500 shown in FIG. 5 is for illustration only.

FIG. 5 shows a diagram of multi-nodes ambient sensing system and device embodiment, which is mainly comprised of a multi-node sensor aggregator and individual sensors. The main functionality of MASA is to control individual sensor nodes, collect their sensing data, and interact with other entities through home IoT protocol.

More detailed MASA functional roles are addressed as follows: (1) add and remove the associated individual sensor from the ambient sensing system or device cluster; (2) configure the sensor parameters; (3) turn on/off, reset and restart the individual sensor; (4) obtain diagnostic and configuration data (such as operational states, error or fault messages, a battery power level, sensitivity settings, calibration, etc.) of the individual sensor and MASA itself; (5) collect either raw or processed sensing data from associated individual sensors to analyze and generate ambient sensing detection context; (6) function as an interface or proxy agent with connected IoT systems and devices to expose the individual sensor information or to report sensor detection contexts to other IoT ecosystem, devices, or cloud entity; (7) provide multiple concurrent detection results (such as occupancy, human activity, situational awareness, motion, range information, etc.) reported over the entire coverage area; and (8) configure an ambient sensing coverage area according to user defined zone/room topology where each sub-detection area does not necessarily have a sensor presence.

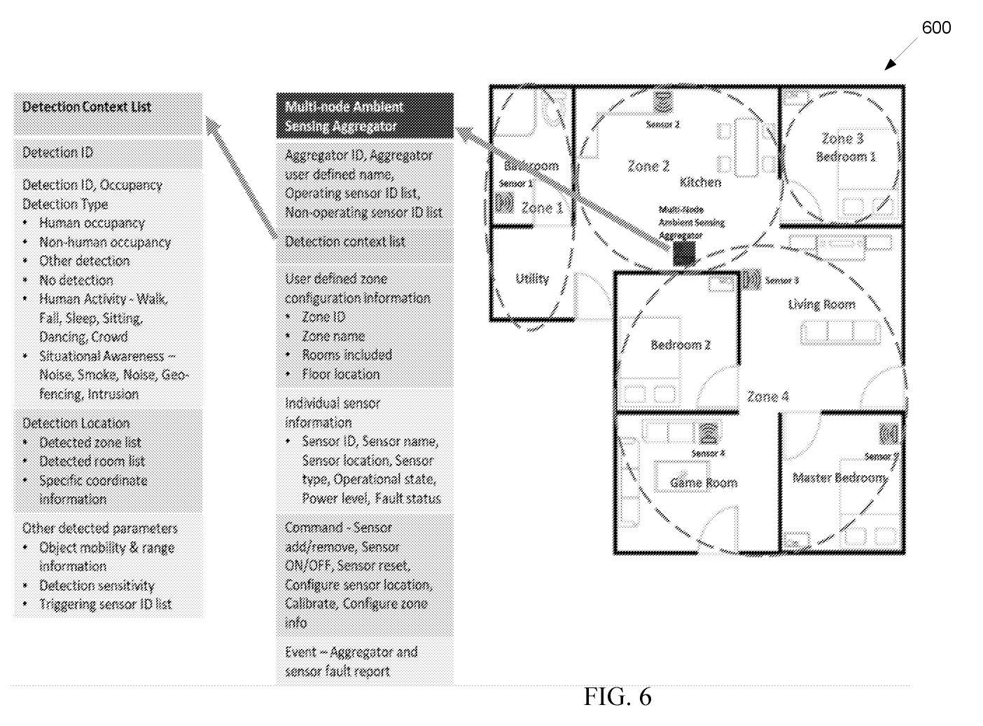

FIG. 6 illustrates an example of a multi-nodes ambient sensing system under smart home IoT 600 according to various embodiments of the present disclosure. An embodiment of the multi-nodes ambient sensing system under smart home IoT 600 shown in FIG. 6 is for illustration only.

FIG. 6 shows an example of the provided multi-nodes ambient sensing system/device architecture embodiment implemented for home IoT application.

In this example, there are 5 individual sensors such as 1 MASA unit and 4 user defined zone-to-room mapping areas. Note that detection zones does not overlap each other so that the zone can be distinctively detectable which is intended by the user.

The advantages of the provided zone designation are as follows: (1) a detection zone area can be scalable according to the sensor capability. If sensor capability allows a higher detection location resolution, then a user can define a zone to be equal to the room area; and (2) in terms of sensor location and detection zone designation, there is a great deal of flexibility of mapping the zone area and a sensor presence. Zone designation may not have an individual sensor node presence within the zone so long as there exists a detection context reportable. On the other hand, a single zone can be designated to encompass multiple sensors.

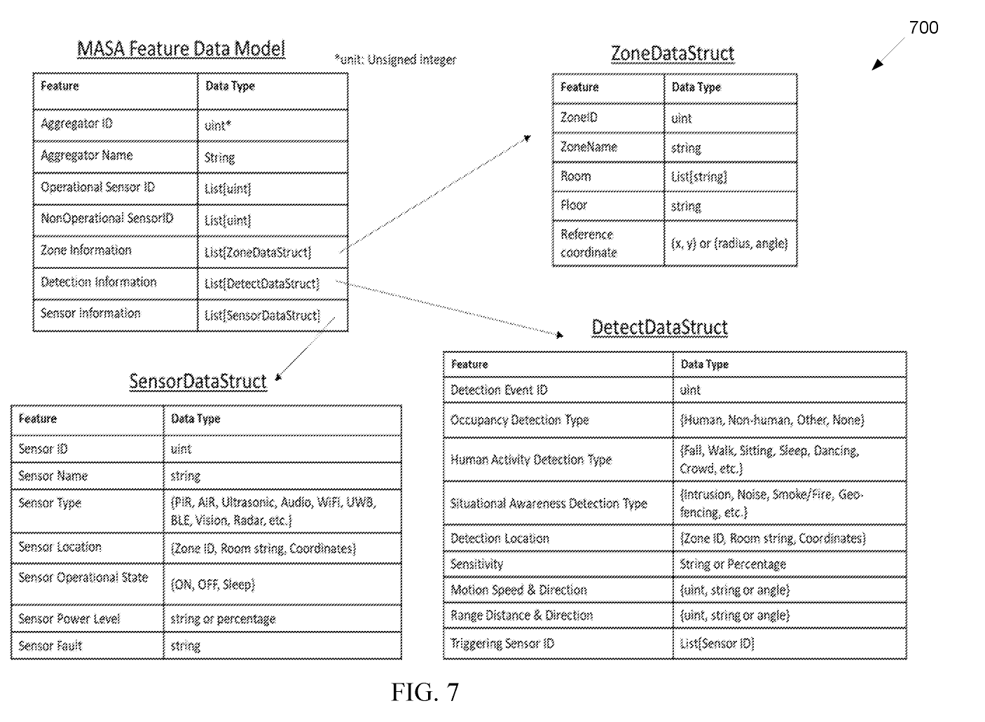

FIG. 7 illustrates an example of data modeling for a multi-nodes ambient sensing system 700 according to various embodiments of the present disclosure. An embodiment of the data modeling example of multi-nodes ambient sensing system 700 shown in FIG. 7 is for illustration only.

FIG. 7 shows a detailed illustration of the provided multi-nodes ambient sensing system/device architecture embodiment for a data model representation for a home IoT protocol.

FIG. 7 shows how the provided multi-nodes ambient sensing embodiment can be applied to data modeling of any IoT protocol.

The following descriptions explain the data modeling features in detail.

In one embodiment, a MASA data model contains feature information about a unique MASA ID, a MASA name, currently operating or non-operating sensor ID list. The MASA includes basic information; zones, detection types, and sensors. Each information is available through a list of data structure.

In one embodiment, the zone information can be defined by a user or some automated process, which covers a detection area of interest. The entire detection coverage area can be represented by making a list of zone data structure. Each zone data structure contains information about a unique zone ID, a zone name, room names that the zone is encompassing, a floor, and a reference coordinate position to identify a distinct position from other zones.

In one embodiment, detection information can accommodate multiple and simultaneous detection event occurred throughout an entire detection area which is mapped by the above zone information. Each unique detection event occurrence can be represented by a single detection data structure. Each detection data structure contains a unique detection event ID and detection context types; occupancy detection for a human or non-human object, human activity detection such as fall, walk, sitting, sleeping, lying, dancing, crowding, etc., and situational awareness detection such as intrusion, accident noise, smoke or fire, and geo-fencing indicate a restricted area. Each detection data structure also contains the location information where the detection has occurred, represented by a zone ID, a room, and a coordinate position. This detection location information can contain multiple locations by making a list of detection location. Other sensing parameters of interest can be included; a sensitivity of detection, a motion speed and direction estimation, an object or human range information such as distance and direction, and individual sensor IDs that are linked to the detection event.

Sensor information can be represented as a list of sensor data structure. This sensor information is meant to be provided to other devices or IoT eco-systems via MASA as an interface proxy. Each sensor data structure contains a unique sensor ID associated with MASA, a sensor name, a sensor type describing a sensing modality, a sensor location such as zone ID, a room, a coordinate position, and other diagnostic information such as an operational state, a power level if a battery operated, any fault detection message may require calibration, a power cycle, or a factory reset operation.

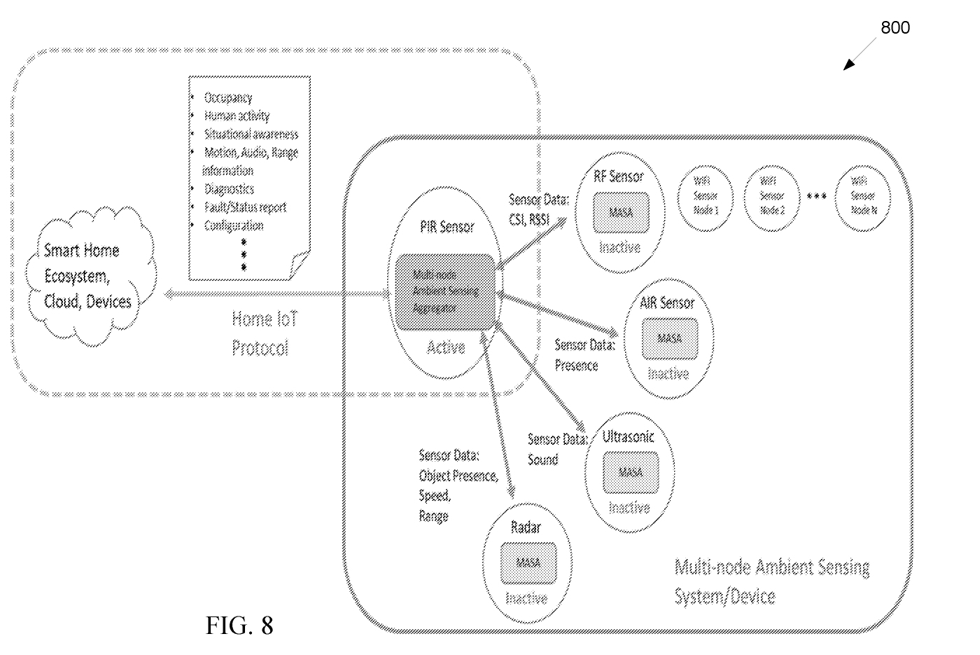

In one embodiment, a multi-nodes ambient sensing system architecture can be viewed as MASA centric architecture design because MASA may be an independent entity and solely interface with individual sensors. However, it is also possible to conceive an alternative multi-nodes ambient sensing system architecture where MASA is not an independent entity but a sub-functional entity to be embedded inside each sensor node as shown in FIG. 8.

FIG. 8 illustrates an example of a 2^{nd} multi-nodes ambient sensing system 800 according to various embodiments of the present disclosure. An embodiment of the multi-nodes ambient sensing system 800 shown in FIG. 8 is for illustration only.

In one embodiment, MASA’s roles may not be changed and remains as it is. However, because MASA is embedded to all sensors, now it is possible that any sensor can function as MASA and reduce a potential system risk when there is a functional fault in a primarily functioning MASA.

In one embodiment, a more resilient sensor system is provided. In this embodiment, additional MASA managerial features may be necessary to designate which sensor’s MASA may be active in case of a primarily functioning MASA role change from one sensor to another sensor. This managerial task may perform an operation of MASA parameter updates among all sensors.

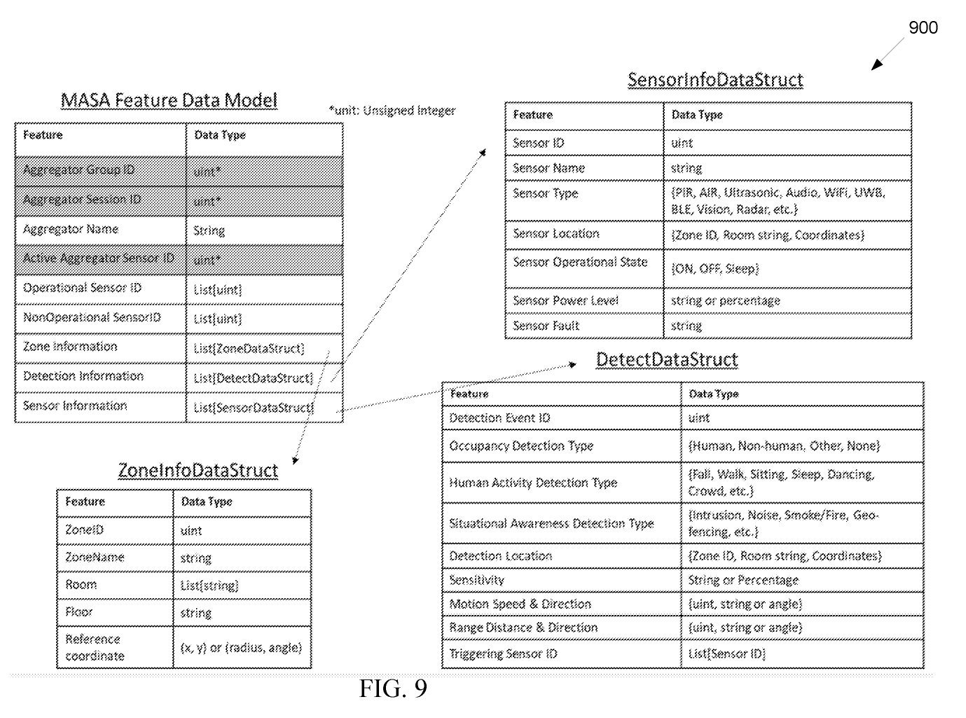

FIG. 9 illustrates an example of a data modeling for a 2^{nd} multi-nodes ambient sensing system 900 according to various embodiments of the present disclosure related to FIG. 8. An embodiment of the data modeling example of 2^{nd} multi-nodes ambient sensing system 900 shown in FIG. 9 is for illustration only.

FIG. 9 shows a new data modeling of this alternative embodiment, and feature differences and MASA managerial task related to FIG. 8 are explained next.

In one embodiment, additional features are provided to reflect the architecture change.

In one embodiment, instead of an aggregator ID, there is an aggregator group ID since all sensors have MASA and those MASA may belong to one group identity.

In one embodiment, an aggregator session ID is created to denote any active aggregator status change from one sensor to another sensor. Whenever there is an active MASA change, the session ID may increase by one.

In one embodiment, an active aggregator sensor ID shows which sensor’s MASA is active currently. It may be one sensor from the list of an operational sensor ID. There may be only one active MASA sensor within each aggregator group ID. The selection of active aggregator sensor is either based on a user selection or the order of an operational sensor ID list. Accordingly, the order of operational sensor ID list may be arranged in the first-come becoming the lowest order index.

For a normal active aggregator change event, the follow steps may be performed: (1) the active MASA may increase an aggregator session ID by one; (2) the next active MASA can be either chosen by a user or selected to the sensor with the lowest order index in an operational sensor ID list; (3) the old active MASA may change an active aggregator sensor ID to the newly chosen one, and change a sensor ID order in the list of an operational sensor ID to be the last one; (4) the old active MASA may broadcast a new aggregator session ID, a new active aggregator sensor ID, an operational sensor ID list, zone Information, and sensor Information; and (5) all sensors may update those broadcasted features and start sending sensing data to the new active MASA sensor.

For an abnormal active aggregator change event (e.g., sudden active MASA sensor power off), the follow steps may be performed: (1) if there is no sensing data reception acknowledgement from the active MASA sensor for a certain time period or multiple reception failures, then whichever sensor who detects this failure condition may initiate as a new active MASA sensor; (2) this candidate MASA sensor may increase an aggregator session ID by one; (3) the candidate MASA sensor may change an active aggregator sensor ID to itself, and change a sensor ID order in the list of an operational sensor ID to be the first one; (4) the candidate MASA may broadcast a new aggregator session ID, a new active aggregator sensor ID, an operational sensor ID list, zone information, and sensor Information; and (5) all sensors may update those broadcasted features and start sending sensing data to the new active MASA sensor.

The embodiments as disclosed in the present disclosure are equally applicable for IoT standardization or actual product/system implementation.

The embodiments as disclosed in the present disclosure can be implemented at human occupant facilities for the purpose of: (1) senior living home care to monitor their safety, activity, and health; (2) home occupancy detection to efficiently operate home devices for better energy management and to promote convenient lifestyle and well-being through intelligent device automation; and (3) security enhancements such as intruder detection, geo-fenced enforcement for children, and early detection of fire hazard.

The embodiments as disclosed in the present disclosure can be implemented for home IoT protocol and data modeling standardization (e.g., Matter) to represent a multi-node ambient sensor.

The embodiments as disclosed in the present disclosure can be implemented in ambient sensing system modeling for a smart home or an intelligent building system where sensor modality and types are diverse, and sensor deployment and distribution is scattered and arbitrary.

The embodiments as disclosed in the present disclosure enable an ambient sensing solution based on RF signal signature collection of various standardized wireless devices (based on WiFi, UWB, BLE, etc.) at home or commercial buildings.

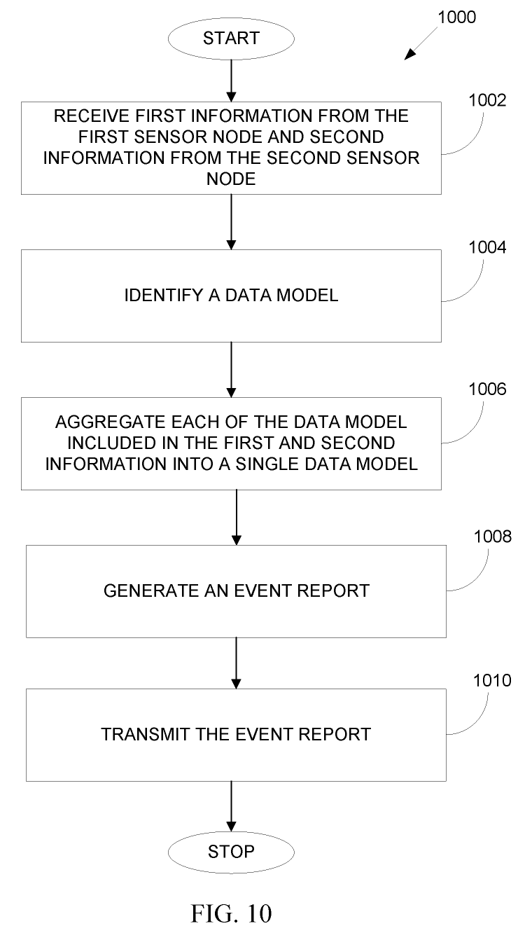

FIG. 10 illustrates a flowchart of a method 1000 for flexible multi-node ambient sensing systems according to various embodiments of the present disclosure. The method 1000 may be performed by an electronic device (e.g., 101 as illustrated in FIG. 1 and FIG. 2). In certain embodiment, the method 1000 may be performed by electronic devices (e.g., 106 and 108-116). In certain embodiment, the method 1000 may be performed by an electronic device (e.g., 307 as illustrated in FIG. 3). In certain embodiment, the method 1000 may be performed by an electronic device (e.g., multi-node ambient sensing aggregator 306 as illustrated in FIG. 3). An embodiment of the method 1000 shown in FIG. 10 is for illustration only. One or more of the components illustrated in FIG. 10 can be implemented in a specialized circuitry configured to perform the noted functions or one or more of the components can be implemented by one or more processors executing instructions to perform the noted functions.

As illustrated in FIG. 10, the method 1000 begins at step 1002. In step 1002, a network entity receives, from at least two sensor nodes comprising a first sensor node and a second sensor node, first information from the first sensor node and second information from the second sensor node.

In step 1004, the network entity identifies a data model included in the first and second information, respectively.

In step 1006, the network entity aggregates each of the data model included in the first and second information into a single data model. In such step, the data model includes zone information, ambient context detection information, and sensor information.

In step 1008, the network entity generates an event report based on the single data model.

In step 1010, the network entity transmits the event report to a sensing analyzer.

In one embodiment, the network entity identifies a sensing operation mode for each of the first and second sensor nodes, identifies to diagnose a sensor fault for each of the first and second sensor nodes, and identifies a sensor operation status for each of the first and second sensor nodes.

In one embodiment, the network entity configures, based on a zone defined by a user, a flexible sensor coverage area for each of the first and second sensor nodes.

In one embodiment, the ambient context detection information includes an occupancy type, an activity type, a situation type, an object identification type, and a detection location of the first and second sensor nodes.

In one embodiment, the occupancy type is identified as a human type or a non-human type with an object identification.

In one embodiment, the detection location is identified as a location of zone or a location of room.

In one embodiment, the sensing analyzer is connected with a user of the sensing analyzer via a wireless or wired communication protocol, the network entity comprises a multiple-nodes ambient sensor aggregator (MASA), the MASA controls the first and second sensor nodes to collect and analyze sensing information received from the first and second sensor nodes, and the sensing information includes the first and second information.

In one embodiment, the network entity receives, from the first and second sensor nodes, ambient sensing context for sensing modality and capability of the first and second sensor nodes. In such embodiment, the context includes at least one of a detection identifier (ID), detection event context, detection location information including information of zones, rooms, or a place identified based on coordinates, active sensor nodes information, object mobility information including a speed and direction, an object range distance, or a detection sensitivity, and a level of confidence and accuracy.

In one embodiment, the network entity adds a third sensor node and remove at least one of the first sensor node or the second sensor node, configures sensor node parameters including sensitivity and accuracy parameters for the first sensor node and the second sensor node, turns on and off at least one of the first sensor node or the second sensor node, and configures to receive at least one of an error or fault message, a battery power level, a level of sensitivity, a level of calibration, or a level of accuracy.

In one embodiment, the network entity comprises setting the network entity as an interface circuit or a proxy agent to provide ambient sensing information for IoT device in an IoT system.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A network entity for an ambient sensing operation, the network entity comprising:
a transceiver configured to receive, from at least two sensor nodes comprising a first sensor node and a second sensor node, first information from the first sensor node and second information from the second sensor node; and
a processor operably coupled to the transceiver, the processor configured to:
identify a data model included in the first and second information, respectively,
aggregate each of the data model included in the first and second information into a single data model, wherein the data model includes zone information, ambient context detection information, and sensor information, and
generate an event report based on the single data model,
wherein the transceiver is further configured to transmit the event report to a sensing analyzer.

2. The network entity of claim 1, wherein the processor is further configured to:
identify a sensing operation mode for each of the first and second sensor nodes;
identify to diagnose a sensor fault for each of the first and second sensor nodes; and
identify a sensor operation status for each of the first and second sensor nodes.

3. The network entity of claim 1, wherein the processor is further configured to configure, based on a zone defined by a user, a flexible sensor coverage area for each of the first and second sensor nodes.

4. The network entity of claim 1, wherein the ambient context detection information includes an occupancy type, an activity type, a situation type, an object identification type, and a detection location of the first and second sensor nodes.

5. The network entity of claim 4, wherein the occupancy type is identified as a human type or a non-human type with an object identification.

6. The network entity of claim 4, wherein the detection location is identified as a location of zone or a location of room.

7. The network entity of claim 1, wherein:
the sensing analyzer is connected with a user of the sensing analyzer via a wireless or wired communication protocol;
the network entity comprises a multiple-nodes ambient sensor aggregator (MASA);
the MASA controls the first and second sensor nodes to collect and analyze sensing information received from the first and second sensor nodes; and
the sensing information includes the first and second information.

8. The network entity of claim 1, wherein:
the transceiver is further configured to receive, from the first and second sensor nodes, ambient sensing context for sensing modality and capability of the first and second sensor nodes; and
the context includes at least one of a detection identifier (ID), detection event context, detection location information including information of zones, rooms, or a place identified based on coordinates, active sensor nodes information, object mobility information including a speed and direction, an object range distance, or a detection sensitivity, and a level of confidence and accuracy.

9. The network entity of claim 1, wherein the processor is further configured to:
add a third sensor node and remove at least one of the first sensor node or the second sensor node;
configure sensor node parameters including sensitivity and accuracy parameters for the first sensor node and the second sensor node;
turn on and off at least one of the first sensor node or the second sensor node; and
configure to receive at least one of an error or fault message, a battery power level, a level of sensitivity, a level of calibration, or a level of accuracy.

10. The network entity of claim 1, wherein the processor is further configured to set the network entity as an interface circuit or a proxy agent to provide ambient sensing information for Internet of things (IoT) device in an IoT system.

11. A method of a network entity for an ambient sensing operation, the method comprising:
receiving, from at least two sensor nodes comprising a first sensor node and a second sensor node, first information from the first sensor node and second information from the second sensor node;
identifying a data model included in the first and second information, respectively;
aggregating each of the data model included in the first and second information into a single data model, wherein the data model includes zone information, ambient context detection information, and sensor information;
generating an event report based on the single data model; and
transmitting the event report to a sensing analyzer.

12. The method of claim 11, further comprising:
identifying a sensing operation mode for each of the first and second sensor nodes;
identifying to diagnose a sensor fault for each of the first and second sensor nodes; and
identifying a sensor operation status for each of the first and second sensor nodes.

13. The method of claim 11, further comprising: configuring, based on a zone defined by a user, a flexible sensor coverage area for each of the first and second sensor nodes.

14. The method of claim 11, wherein the ambient context detection information includes an occupancy type, an activity type, a situation type, an object identification type, and a detection location of the first and second sensor nodes.

15. The method of claim 14, wherein the occupancy type is identified as a human type or a non-human type with an object identification.

16. The method of claim 14, wherein the detection location is identified as a location of zone or a location of room.

17. The method of claim 11, wherein:
the sensing analyzer is connected with a user of the sensing analyzer via a wireless or wired communication protocol;
the network entity comprises a multiple-nodes ambient sensor aggregator (MASA);
the MASA controls the first and second sensor nodes to collect and analyze sensing information received from the first and second sensor nodes; and
the sensing information includes the first and second information.

18. The method of claim 11, further comprising receiving, from the first and second sensor nodes, ambient sensing context for sensing modality and capability of the first and second sensor nodes,
wherein the context includes at least one of a detection identifier (ID), detection event context, detection location information including information of zones, rooms, or a place identified based on coordinates, active sensor nodes information, object mobility information including a speed and direction, an object range distance, or a detection sensitivity, and a level of confidence and accuracy.

19. The method of claim 11, further comprising:
adding a third sensor node and remove at least one of the first sensor node or the second sensor node;
configuring sensor node parameters including sensitivity and accuracy parameters for the first sensor node and the second sensor node;
turning on and off at least one of the first sensor node or the second sensor node; and
configuring to receive at least one of an error or fault message, a battery power level, a level of sensitivity, a level of calibration, or a level of accuracy.

20. The method of claim 11, further comprising setting the network entity as an interface circuit or a proxy agent to provide ambient sensing information for Internet of things (IoT) device in an IoT system.
